(19) United States
(12) Patent Application Publication
(10) Pub. No.: US 2024/0366457 A1
(43) Pub. Date: Nov. 7, 2024

(54) REHABILITATION APPARATUS

(71) Applicants: P&A TECHNOLOGIES INC., Morioka-shi, Iwate (JP); HOLONIC SYSTEMS LTD., Shiwa-cho, Shiwa-gun, Iwate (JP); NATIONAL UNIVERSITY CORPORATION, IWATE UNIVERSITY, Morioka-shi, Iwate (JP); TOHOKU UNIVERSITY, Aoba-ku, Sendai-shi, Miyagi (JP)

(72) Inventors: Kazuaki Ozeki, Morioka (JP); Eisuke Takebe, Morioka (JP); Minoru Hiyama, Shiwa (JP); Tasuku Miyoshi, Morioka (JP); Shinichi Izumi, Sendai (JP)

(21) Appl. No.: 18/291,807

(22) PCT Filed: Aug. 29, 2022
(86) PCT No.: PCT/JP2022/032315

§ 371 Date: Jan. 24, 2024

(30) Foreign Application Priority Data
Aug. 30, 2021 (JP) 2021-139884

(51) Int. Cl. A61H 1/02

(52) U.S. Cl. CPC A61H 1/0288; A61H 2201/1207; A61H 2201/1463; A61H 2201/1638; A61H 2201/5058; A61H 2201/5069; A61H 2201/5092

(57) ABSTRACT

A rehabilitation apparatus includes: a right movable unit (Ka) to be coordinated with a right hand (Ha); a left movable unit (Kb) to be coordinated with a left hand (Hb); a right motor (Ma) configured to turn the right movable unit (Ka); a left motor (Mb) configured to turn the left movable unit (Kb); and a control unit including motor controlling device for controlling the right motor (Ma) and the left motor (Mb). The motor controlling device is configured to cause bilateral control to be performed, in which, when the right motor (Ma) is rotated by an external force of the right hand (Ha) or when the left motor (Mb) is rotated by an external force of the left hand (Kb), similarly to one motor rotated by this external force, another motor is electrically rotated so as to follow the one motor, in a direction reverse to a rotation direction of the one motor.

### TECHNICAL FIELD

The present invention relates to an apparatus for performing rehabilitation of a patient whose part of a body has been paralyzed due to after-effects of a stroke or the like, more particularly, to a rehabilitation apparatus for performing, when any one of right and left hands is a healthy hand being healthy and another of the right and left hands is a paralyzed hand being paralyzed and disabled, a training of moving the paralyzed hand similarly to the healthy hand.

### BACKGROUND ART

Hitherto, as this type of rehabilitation apparatus, for example, a technology described in JP 5928851 B2 (Patent Literature 1) has been known. This rehabilitation apparatus is a rehabilitation apparatus for performing, when any one of right and left hands is a healthy hand being healthy and another of the right and left hands is a paralyzed hand being paralyzed and disabled, a training of moving the paralyzed hand similarly to the healthy hand. The rehabilitation apparatus includes a paralyzed-hand movable unit to be moved by the paralyzed hand, a healthy-hand movable unit to be moved by the healthy hand, an exercise detection unit for detecting an exercise of the healthy hand, an assistance application unit for applying assistance to the paralyzed-hand movable unit for the paralyzed hand so that an exercise substantially equivalent to the exercise of the healthy hand detected by the exercise detection unit is performed, and a display for displaying a normal image obtained by picking up an image of the exercise of the healthy hand and an inverted image obtained by inverting this normal image in mirror symmetry. In addition, the exercise detection unit is formed of a camera for picking up an image of a predetermined motion of the healthy hand, and the control by the assistance application unit is performed while the display is caused to display a desired indication based on image data acquired by this camera.

In this manner, when the training of the paralyzed hand is performed, the patient coordinates the paralyzed hand with the paralyzed-hand movable unit, and coordinates the healthy hand with the healthy-hand movable unit. Thus, the patient performs an exercise of similarly moving the healthy hand and the paralyzed hand while visually recognizing the normal image and the inverted image displayed on the display. At this time, assistance is applied to the paralyzed hand by the assistance application unit, and hence the exercise of the paralyzed hand can be reliably performed. Further, the patient views a video that looks as if both the healthy hand and the paralyzed hand were moving smoothly. Accordingly, this visual input stimulates the brain to provide a sense that the patient himself or herself is smoothly moving the paralyzed hand being paralyzed, thereby producing an action of assisting the exercise of the paralyzed hand and being capable of obtaining a high rehabilitation effect.

### CITATION LIST

### Patent Literature

[PTL 1] JP 5928851 B2

### SUMMARY OF INVENTION

### Technical Problem

Incidentally, as modes of paralysis, there are two modes, specifically, a case in which the left hand is the paralyzed hand and the right hand is the healthy hand and a case in which the right hand is the paralyzed hand and the left hand is the healthy hand. In the related-art rehabilitation apparatus described above, the paralyzed-hand movable unit is dedicated to the paralyzed hand, and the healthy-hand movable unit is dedicated to the healthy hand as well. Accordingly, when the left hand is the paralyzed hand and the right hand is the healthy hand, it is required to prepare an apparatus for left hand paralysis in which the paralyzed-hand movable unit is installed on the left side and the healthy-hand movable unit is installed on the right side. Conversely, when the right hand is the paralyzed hand and the left hand is the healthy hand, it is required to prepare an apparatus for right hand paralysis in which the paralyzed-hand movable unit is installed on the right side and the healthy-hand movable unit is installed on the left side. Accordingly, in order to handle those two modes of paralysis, two apparatus of the apparatus for left hand paralysis and the apparatus for right hand paralysis are required, resulting in a problem of bad efficiency.

Further, the control by the assistance application unit is performed based on the image data acquired by the camera, and hence the movement of the healthy hand cannot be faithfully transmitted to the paralyzed hand, and there is some time lag for reflecting the movement of the healthy hand to the paralyzed hand, resulting in another problem of poor responsiveness.

The present invention has been made in view of the above-mentioned problems, and has an object to provide a rehabilitation apparatus which is capable of handling two modes of paralysis by one apparatus to improve versatility, is capable of faithfully transmitting a movement of a healthy hand to a paralyzed hand, and is increased in responsiveness to improve performance and improve reliability.

### Solution to Problem

In order to achieve the above-mentioned object, according to the present invention, there is provided a rehabilitation apparatus for performing, when any one of right and left hands is a healthy hand being healthy and another of the right and left hands is a paralyzed hand being paralyzed and disabled, a training of moving the paralyzed hand similarly to the healthy hand, the rehabilitation apparatus including: a right movable unit to be coordinated with a right hand; a left movable unit to be coordinated with a left hand; a right motor configured to electrically turn the right movable unit; a left motor configured to electrically turn the left movable unit; and a control unit including motor controlling device for controlling the right motor and the left motor.

The motor controlling device includes: a right motor driving device for driving the right motor; a left motor driving device for driving the left motor; and a drive controlling device for causing the right motor driving device and the left motor driving device to perform bilateral control in which, when the right motor is rotated via the right movable unit by an external force of the right hand or when the left motor is rotated via the left movable unit by an external force of the left hand, similarly to one motor rotated by the external force, another motor is electrically rotated so as to follow the one motor, in a direction reverse to a rotation direction of the one motor.

In this manner, when the training of the paralyzed hand is performed, no matter which of the right hand or the left hand is the paralyzed hand, the patient coordinates the right hand with the right movable unit and coordinates the left hand with the left movable unit, and moves the right and left hands in the same way. In this case, when the right motor is rotated via the right movable unit by an external force of the right hand, or when the left motor is rotated via the left movable unit by an external force of the left hand, the drive controlling device performs bilateral control in which, similarly to one motor rotated by the external force, another motor is electrically rotated so as to follow the one motor, in a direction reverse to a rotation direction of the one motor. In general, the movement of the movable unit on the healthy hand side is smooth, and hence the movable unit on the paralyzed hand side is moved so as to follow the movement on the healthy hand side. Accordingly, no matter which of the right hand or the left hand is the paralyzed hand, the paralyzed hand can be moved similarly to the healthy hand. Accordingly, the two modes of paralysis, specifically, the case in which the left hand is the paralyzed hand and the right hand is the healthy hand and the case in which the right hand is the paralyzed hand and the left hand is the healthy hand, can be handled by one apparatus, thereby being capable of improving the versatility.

Further, the drive controlling device performs the bilateral control, and hence the movement of the healthy hand can be faithfully transmitted to the paralyzed hand. In addition, its responsiveness is well, and hence, as compared to the related art, the performance can be improved, and the reliability can be improved.

In this case, the following configuration is effective. The rehabilitation apparatus includes: a right rotation angle detector configured to detect a rotation angle of the right motor; and a left rotation angle detector configured to detect a rotation angle of the left motor, wherein the drive controlling device is configured to cause the right motor driving device and the left motor driving device to perform control based on the rotation angle detected by the right rotation angle detector and the rotation angle detected by the left rotation angle detector. Through comparison between the detected rotation angles, the motors can be controlled to perform reverse rotation so that a difference between those angles is reduced.

Further, as required, the control unit includes: a right movable angle range setting device for setting, through input from an input unit, a right movable angle range having a starting point position of the right movable unit as a reference; a left movable angle range setting device for setting, through input from the input unit, a left movable angle range having a starting point position of the left movable unit as a reference; and a storage device for storing a right motor rotation angle range of the right motor corresponding to the right movable angle range set by the right movable angle range setting device and a left motor rotation angle range of the left motor corresponding to the left movable angle range set by the left movable angle range setting device.

The motor controlling device includes: a right rotation angle restricting device for allowing electric drive of the right motor by the right motor driving device when a right rotation angle detected by the right rotation angle detector falls within the right motor rotation angle range stored in the storage device, and restricting the electric drive of the right motor by the right motor driving device when the right rotation angle detected by the right rotation angle detector has reached an upper limit or a lower limit of the right motor rotation angle range stored in the storage device; and a left rotation angle restricting device for allowing electric drive of the left motor by the left motor driving device when a left rotation angle detected by the left rotation angle detector falls within the left motor rotation angle range stored in the storage device, and restricting the electric drive of the left motor by the left motor driving device when the left rotation angle detected by the left rotation angle detector has reached an upper limit or a lower limit of the left motor rotation angle range stored in the storage device.

In this manner, through input from the input unit, the right movable angle range setting device sets the right movable angle range, and the left movable angle range setting device sets the left movable angle range. The storage device stores the right motor rotation angle range of the right motor corresponding to the right movable angle range and the left motor rotation angle range of the left motor corresponding to the left movable angle range. When the right and left hands are moved in the same way under this state, the right rotation angle detector detects the rotation angle of the right motor, and the left rotation angle detector detects the rotation angle of the left motor. The right rotation angle restricting device performs electric drive of the right motor when the right rotation angle detected by the right rotation angle detector falls within the right motor rotation angle range, and restricts the electric drive of the right motor by the right motor driving device when the right rotation angle detected by the right rotation angle detector has reached the upper limit or the lower limit of the right motor rotation angle range. Meanwhile, the left rotation angle restricting device performs electric drive of the left motor when the left rotation angle detected by the left rotation angle detector falls within the left motor rotation angle range, and restricts the electric drive of the left motor by the left motor driving device when the left rotation angle detected by the left rotation angle detector has reached the upper limit or the lower limit of the left motor rotation angle range. Accordingly, the right motor or the left motor whose drive has been restricted is not electrically rotated forcibly, and hence the electric movement of the right movable unit or the left movable unit can be restricted, and forcible turning can be suppressed.

For example, when the left hand is the paralyzed hand and the right hand is the healthy hand, through input from the input unit, the left movable angle range setting device sets the left movable angle range of the left movable unit. The right movable angle range of the right movable unit is not particularly required to be set. Meanwhile, for example, when the right hand is the paralyzed hand and the left hand is the healthy hand, through input from the input unit, the right movable angle range setting device sets the right movable angle range of the right movable unit. The left movable angle range of the left movable unit is not particularly required to be set. In this manner, the turning range of the movable unit on the paralyzed hand side can be limited, and hence forcible movement of the paralyzed hand can be prevented from being performed, thereby being capable of ensuring safety of the paralyzed hand. That is, which hand is the paralyzed hand is known in advance, and further how much amount the paralyzed hand can move as compared to the healthy hand is known to some extent, and hence the training can be performed without imposing a burden to the paralyzed hand.

Further, as required, the control unit includes: a right upper-limit speed setting device for setting, through input from an input unit, a right upper-limit speed that is an upper limit of a turning speed of the right movable unit; a left upper-limit speed setting device for setting, through input from the input unit, a left upper-limit speed that is an upper limit of a turning speed of the left movable unit; and a storage device for storing a right motor upper-limit speed of the right motor corresponding to the right upper-limit speed set by the right upper-limit speed setting device and a left motor upper-limit speed of the left motor corresponding to the left upper-limit speed set by the left upper-limit speed setting device.

The motor controlling device includes: a right rotation speed calculating device for calculating a rotation speed of the right motor; a left rotation speed calculating device for calculating a rotation speed of the left motor; a right rotation speed restricting device for allowing electric drive of the right motor by the right motor driving device when a right rotation speed calculated by the right rotation speed calculating device is less than the right motor upper-limit speed stored in the storage device, and restricting the electric drive of the right motor by the right motor driving device when the right rotation speed calculated by the right rotation speed calculating device is equal to or larger than the right motor upper-limit speed stored in the storage device; and a left rotation speed restricting device for allowing electric drive of the left motor by the left motor driving device when a left rotation speed calculated by the left rotation speed calculating device is less than the left motor upper-limit speed stored in the storage device, and restricting the electric drive of the left motor by the left motor driving device when the left rotation speed calculated by the left rotation speed calculating device is equal to or larger than the left motor upper-limit speed stored in the storage device.

In this manner, through input from the input unit, the right upper-limit speed setting device sets the right upper-limit speed, and the left upper-limit speed setting device sets the left upper-limit speed. The storage device stores the right motor upper-limit speed of the right motor corresponding to the right upper-limit speed and the left motor upper-limit speed of the left motor corresponding to the left upper-limit speed. When the right and left hands are moved in the same way under this state, the right rotation speed calculating device calculates the rotation speed of the right motor, and the left rotation speed calculating device calculates the rotation speed of the left motor. The right rotation speed restricting device allows the electric drive of the right motor by the right motor driving device when the right rotation speed calculated by the right rotation speed calculating device is less than the right motor upper-limit speed, and restricts the electric drive of the right motor by the right motor driving device when the right rotation speed calculated by the right rotation speed calculating device is equal to or larger than the right motor upper-limit speed. Meanwhile, the left rotation speed restricting device allows the electric drive of the left motor by the left motor driving device when the left rotation speed calculated by the left rotation speed calculating device is less than the left motor upper-limit speed, and restricts the electric drive of the left motor by the left motor driving device when the left rotation speed calculated by the left rotation speed calculating device is equal to or larger than the left motor upper-limit speed. Accordingly, the right motor or the left motor whose drive has been restricted is not electrically rotated forcibly, and hence the electric movement of the right movable unit or the left movable unit can be restricted, and forcible turning can be suppressed.

For example, when the left hand is the paralyzed hand and the right hand is the healthy hand, through input from the input unit, the left upper-limit speed setting device sets the left upper-limit speed of the left movable unit. The right upper-limit speed of the right movable unit is not particularly required to be set. Meanwhile, for example, when the right hand is the paralyzed hand and the left hand is the healthy hand, through input from the input unit, the right upper-limit speed setting device sets the right upper-limit speed of the right movable unit. The left upper-limit speed of the left movable unit is not particularly required to be set. In this manner, the turning speed of the movable unit on the paralyzed hand side can be limited, and hence forcible movement of the paralyzed hand can be prevented from being performed, thereby being capable of ensuring safety of the paralyzed hand. That is, which hand is the paralyzed hand is known in advance, and further how much amount the paralyzed hand can move as compared to the healthy hand is known to some extent, and hence the training can be performed without imposing a burden to the paralyzed hand.

Further, as required, the control unit includes: a right upper-limit force setting device for setting, through input from an input unit, a right upper-limit force that is an upper limit of a turning force of the right movable unit; a left upper-limit force setting device for setting, through input from the input unit, a left upper-limit force that is an upper limit of a turning force of the left movable unit; and a storage device for storing a right motor upper-limit load of the right motor corresponding to the right upper-limit force set by the right upper-limit force setting device and a left motor upper-limit load of the left motor corresponding to the left upper-limit force set by the left upper-limit force setting device.

The motor controlling device includes: a right load calculating device for calculating a load of the right motor; a left load calculating device for calculating a load of the left motor; right rotation force restricting device for allowing electric drive of the right motor by the right motor driving device when a right load calculated by the right load calculating device is less than the right motor upper-limit load stored in the storage device, and restricting the electric drive of the right motor by the right motor driving device when the right load calculated by the right load calculating device is equal to or larger than the right motor upper-limit load stored in the storage device; and a left rotation force restricting device for allowing electric drive of the left motor by the left motor driving device when a left load calculated by the left load calculating device is less than the left motor upper-limit load stored in the storage device, and restricting the electric drive of the left motor by the left motor driving device when the left load calculated by the left load calculating device is equal to or larger than the left motor upper-limit load stored in the storage device.

In this manner, through input from the input unit, the right upper-limit force setting device sets the right upper-limit force, and the left upper-limit force setting device sets the left upper-limit force. The storage device stores the right motor upper-limit load of the right motor corresponding to the right upper-limit force and the left motor upper-limit load of the left motor corresponding to the left upper-limit force. When the right and left hands are moved in the same way under this state, the right load calculating device calculates the load of the right motor, and the left load calculating device calculates the load of the left motor. The right rotation force restricting device allows the electric drive of the right motor by the right motor driving device when the right load calculated by the right load calculating device is less than the right motor upper-limit load, and restricts the electric drive of the right motor by the right motor driving device when the right load calculated by the right load calculating device is equal to or larger than the right motor upper-limit load. Meanwhile, the left rotation force restricting device allows the electric drive of the left motor by the left motor driving device when the left load calculated by the left load calculating device is less than the left motor upper-limit load, and restricts the electric drive of the left motor by the left motor driving device when the left load calculated by the left load calculating device is equal to or larger than the left motor upper-limit load. Accordingly, the right motor or the left motor whose drive has been restricted is not electrically rotated forcibly, and hence the electric movement of the right movable unit or the left movable unit can be restricted, and forcible turning can be suppressed.

For example, when the left hand is the paralyzed hand and the right hand is the healthy hand, through input from the input unit, the left upper-limit force setting device sets the left upper-limit force of the left movable unit. The right upper-limit force of the right movable unit is not particularly required to be set. Meanwhile, for example, when the right hand is the paralyzed hand and the left hand is the healthy hand, through input from the input unit, the right upper-limit force setting device sets the right upper-limit force of the right movable unit. The left upper-limit force of the left movable unit is not particularly required to be set. In this manner, the turning force of the movable unit on the paralyzed hand side can be limited, and hence forcible movement of the paralyzed hand can be prevented from being performed, thereby being capable of ensuring safety of the paralyzed hand. That is, which hand is the paralyzed hand is known in advance, and further how much amount the paralyzed hand can move as compared to the healthy hand is known to some extent, and hence the training can be performed without imposing a burden to the paralyzed hand.

Moreover, as required, the rehabilitation apparatus is configured such that the control unit includes an emergency stop device for forcibly stopping drive of each of the right motor and the left motor based on an abnormality signal. Safety can thus be ensured.

In addition, as required, the rehabilitation apparatus further includes: a right hand image pickup camera configured to pick up an image of the right hand coordinated with the right movable unit; a left hand image pickup camera configured to pick up an image of the left hand coordinated with the left movable unit; and a display.

The control unit includes: a camera controlling device for controlling the right hand image pickup camera and the left hand image pickup camera; a display displaying device for controlling display of the display; and a mode setting device for performing, through input from the input unit, switching setting to any one of a left hand training mode or a right hand training mode, the left hand training mode being performed when the right hand is the healthy hand and the left hand is the paralyzed hand, the right hand training mode being performed when the right hand is the paralyzed hand and the left hand is the healthy hand.

The camera controlling device includes: an image switching device for enabling image pickup data obtained from the right hand image pickup camera and disabling image pickup data obtained from the left hand image pickup camera when the mode setting device sets the left hand training mode, while disabling the image pickup data obtained from the right hand image pickup camera and enabling the image pickup data obtained from the left hand image pickup camera when the mode setting device sets the right hand training mode; and an inverted image generation device for generating an inverted image by mirror-inverting a normal image enabled by the image switching device.

The display displaying device has a function of displaying, on the display, the normal image enabled by the image switching device and the inverted image generated by the inverted image generation device.

In this manner, it is possible to perform a training of moving a hand corresponding to the another image pickup camera side disabled by the image switching device, while visually recognizing the normal image and the inverted image displayed on the display. That is, when the training of the paralyzed hand is performed, first, the mode setting device sets the left hand training mode when the right hand is the healthy hand and the left hand is the paralyzed hand, and sets the right hand training mode when the right hand is the paralyzed hand and the left hand is the healthy hand. In addition, when the training is performed, the patient performs an exercise of similarly moving the healthy hand and the paralyzed hand while visually recognizing the normal image and the inverted image displayed on the display. In this case, the display displays the normal image of the healthy hand and its inverted image, and hence the patient views a video that looks as if the paralyzed hand was also smoothly moved similarly to the healthy hand. Accordingly, this visual input stimulates the brain to provide a sense that the patient himself or herself is smoothly moving the paralyzed hand being paralyzed, thereby producing an action of assisting the exercise of the paralyzed hand and being capable of obtaining a high rehabilitation effect.

Further, as required, an exercise of the healthy hand and the paralyzed hand is a bending motion of bending other four fingers excluding a thumb from MP joints.

Each of the right movable unit and the left movable unit is provided on a base, and includes: a supporting member configured to support a little finger among the four fingers under a state in which the four fingers are positioned in a vertical direction; a pair of abutment plates provided upright on the supporting member, the pair of abutment plates being configured to face an outer side and an inner side of the four fingers so that the four fingers are brought into abutment against the pair of abutment plates; and a turning shaft provided on a lower side of the supporting member so that an axis of the turning shaft extends along the vertical direction, the turning shaft being configured to turn the supporting member with respect to the base.

In this manner, the exercise of the healthy hand and the paralyzed hand is a bending motion of bending other four fingers excluding the thumb from the MP joints, and an exercise important for the paralyzed hand can be reliably assisted. On the healthy hand side, when the four fingers are flexed to the inner side from the MP joints, the four fingers push the abutment plate on the inner side, and when the four fingers are extended to the outer side from the MP joints, the four fingers push the abutment plate on the outer side. Meanwhile, on the paralyzed hand side, the hand is pushed to be flexed by the abutment plate on the outer side, and the hand is pushed to be extended by the abutment plate on the inner side. This exercise is, for example, a so-called pinching motion in which the four fingers come close to the thumb, and an enhancement effect of exercise capacity of pinching (grasping) by the thumb and the index finger can be promoted.

In this case, it is effective to provide, on the base, a wrist-side holding unit configured to hold a wrist side of a hand having four fingers supported by the supporting member, so as to correspond to each of the right movable unit and the left movable unit. The wrist side is supported, and hence the motion by the four fingers can be smoothly performed.

### Advantageous Effects of Invention

According to the present invention, it is possible to handle, by one apparatus, two modes of paralysis, specifically, a case in which the left hand is the paralyzed hand and the right hand is the healthy hand and a case in which the right hand is the paralyzed hand and the left hand is the healthy hand, to thereby be capable of improving versatility. Further, a movement of the healthy hand can be faithfully transmitted to the paralyzed hand, and moreover, its responsiveness is well, to thereby be capable of improving performance and improving reliability.

### BRIEF DESCRIPTION OF DRAWINGS

FIG. 1 is a perspective view for illustrating a rehabilitation apparatus according to an embodiment of the present invention and its usage state.

FIG. 2 is a perspective view for illustrating an accommodation box of the rehabilitation apparatus according to the embodiment of the present invention.

FIG. 3 is a perspective view for illustrating an internal configuration of the accommodation box of the rehabilitation apparatus according to the embodiment of the present invention.

FIG. 4 is a back-surface side perspective view for illustrating the internal configuration of the accommodation box of the rehabilitation apparatus according to the embodiment of the present invention.

FIG. 5 is a main-part perspective view for illustrating rotation transmission mechanisms of movable units of the rehabilitation apparatus according to the embodiment of the present invention.

FIG. 6 is a plan view for illustrating the movable units in a state at the time of flexing right and left hands in the rehabilitation apparatus according to the embodiment of the present invention.

FIG. 7 is a plan view for illustrating the movable units in a state at the time of extending the right and left hands in the rehabilitation apparatus according to the embodiment of the present invention.

FIG. 8 is a block diagram for illustrating configurations of an input unit and a control unit of the rehabilitation apparatus according to the embodiment of the present invention.

FIG. 9 is a block diagram for illustrating a configuration of a main part of the control unit of the rehabilitation apparatus according to the embodiment of the present invention.

FIG. 10 is a block diagram for illustrating a configuration of another main part of the control unit of the rehabilitation apparatus according to the embodiment of the present invention.

FIG. 11 is a view for illustrating a setting example of a movable angle range in the rehabilitation apparatus according to the embodiment of the present invention.

FIG. 12 is a graph for showing a setting example of an upper-limit speed in the rehabilitation apparatus according to the embodiment of the present invention.

FIG. 13 is a graph for showing a setting example of an upper-limit force in the rehabilitation apparatus according to the embodiment of the present invention.

FIG. 14 (a) is a view for illustrating a display example of a display in the rehabilitation apparatus according to the embodiment of the present invention, and shows the state at the time of flexing the right and left hands.

FIG. 14 (b) is a view for illustrating a display example of the display in the rehabilitation apparatus according to the embodiment of the present invention, and shows the state at the time of extending the right and left hands.

FIG. 15 is a flow chart for illustrating a control flow of the control unit of the rehabilitation apparatus according to the embodiment of the present invention.

### DESCRIPTION OF EMBODIMENTS

Now, based on the attached drawings, a rehabilitation apparatus according to an embodiment of the present invention is described in detail.

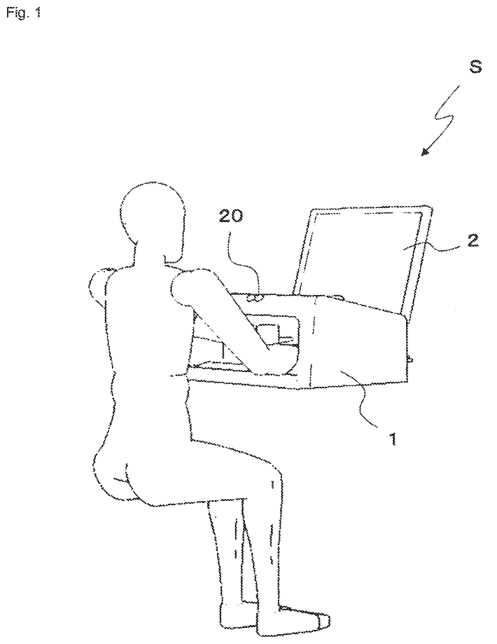

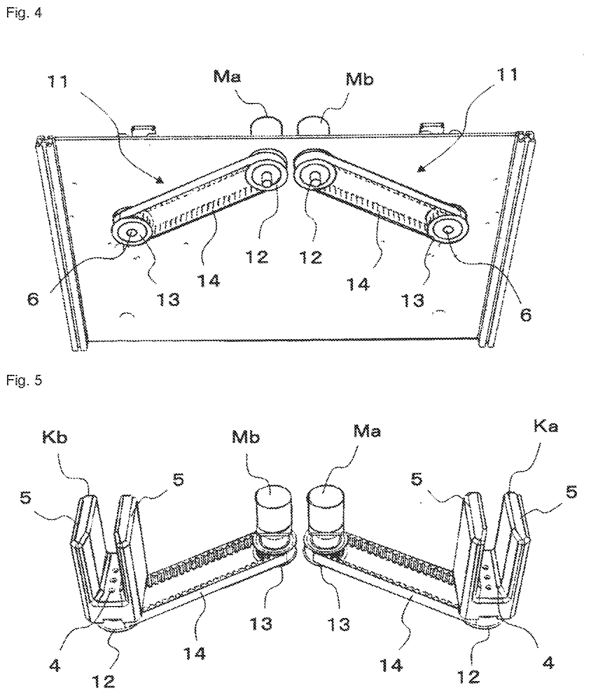

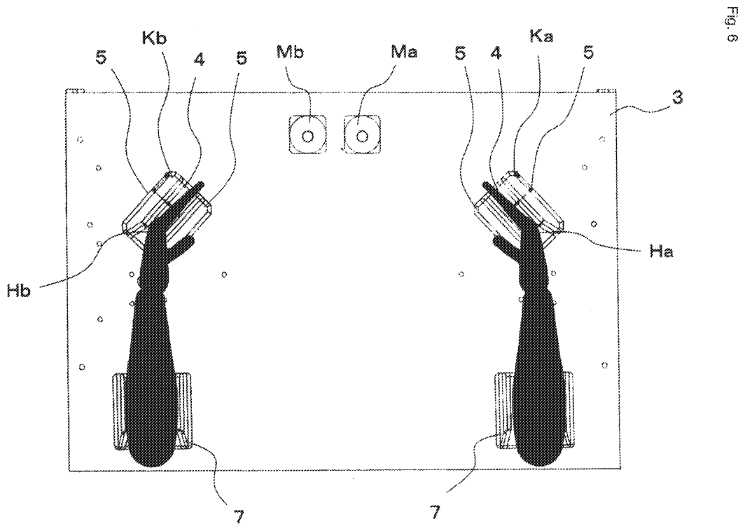

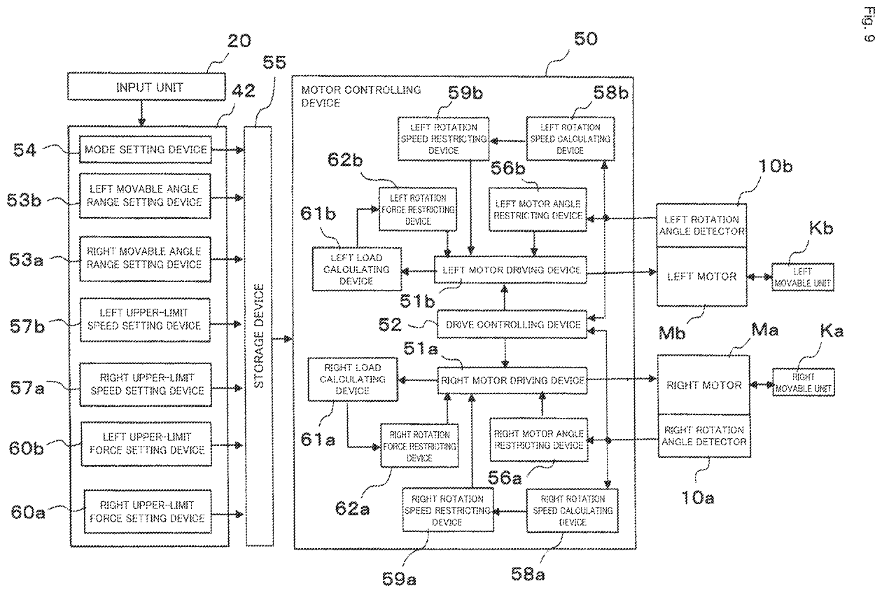

As illustrated in FIG. 1 to FIG. 10, a rehabilitation apparatus S according to the embodiment of the present invention is used for performing, when any one of right and left hands of a target patient is a healthy hand being healthy, and another of the right and left hands is a paralyzed hand being paralyzed and disabled, a training of moving the paralyzed hand similarly to the healthy hand. In the embodiment, an exercise of the healthy hand and the paralyzed hand is performed for an exercise of allowing other four fingers excluding the thumb to be bent from MP joints. Examples of this exercise include a pinching motion (oppositional movement) in which the four fingers come close to the thumb.

The rehabilitation apparatus S includes a front-open rectangular accommodation box 1 accommodating the healthy hand and the paralyzed hand and a display 2 installed on the accommodation box 1 so as to be viewable by the patient.

The accommodation box 1 is placed on a table (not shown) having a height that allows, while the patient sits on a chair (not shown), parts of arms from elbows, which have the healthy hand and the paralyzed hand, to be effortlessly extended and placed in substantially parallel to each other.

In the accommodation box 1, a base 3 is provided. On this base 3, a right movable unit Ka to be coordinated with a right hand Ha and a left movable unit Kb to be coordinated with a left hand Hb are provided. The right movable unit Ka and the left movable unit Kb are arranged in a positional relationship of mirror symmetry, and each include a supporting member 4, a pair of abutment plates 5, and a turning shaft 6. The supporting member 4 supports a little finger among four fingers excluding a thumb of a hand under a state in which the four fingers are positioned in a vertical direction. The pair of abutment plates 5 are provided upright on the supporting member 4, and face an outer side and an inner side of the four fingers so that those four fingers are brought into abutment against the abutment plates 5. The turning shaft 6 is provided on a lower side of the supporting member 4 so that its axis extends along the vertical direction, and supports the supporting member 4 so as to be turnable with respect to the base 3. Further, on the base 3 on the opening port side of the accommodation box 1, wrist-side holding units 7 are provided so as to correspond to the right movable unit Ka and the left movable unit Kb, respectively. The wrist-side holding units 7 each hold a wrist side of the hand whose four fingers are supported by the supporting member 4.

Further, on the base 3, a right motor Ma and a left motor Mb are provided. The right motor Ma electrically turns the right movable unit Ka, and the left motor Mb electrically turns the left movable unit Kb. The motors can be formed of, for example, servomotors or stepping motors exhibiting no step-out, which have the same performance. The right motor Ma accompanies a right rotation angle detector 10a formed of an encoder for detecting a rotation angle of the right motor Ma. The left motor Mb accompanies a left rotation angle detector 10b formed of an encoder for detecting a rotation angle of the left motor Mb. On the back surface side of the base 3, rotation transmission mechanisms 11 for transmitting rotations of the respective motors Ma and Mb to the corresponding movable units Ka and Kb are provided. Each of the rotation transmission mechanisms 11 is formed of a tooth-profile main pulley 12 provided on a motor shaft, a tooth-profile driven pulley 13 provided on the turning shaft 6 of a corresponding one of the movable units Ka and Kb, and an endless timing belt 14 looped around the main pulley 12 and the driven pulley 13. The rotation ratio is set to 1:1 in the embodiment.

Further, in the accommodation box 1, a right hand image pickup camera 15a, a left hand image pickup camera 15b, a right LED lamp 16a (FIG. 8), and a left LED lamp 16b (FIG. 8) are provided. The right hand image pickup camera 15a picks up an image of the right hand Ha coordinated with the right movable unit Ka. The left hand image pickup camera 15b picks up an image of the left hand Hb coordinated with the left movable unit Kb. The right LED lamp 16a illuminates the right movable unit Ka. The left LED lamp 16b illuminates the left movable unit Kb. Further, in the accommodation box 1, a control unit 40 for performing various types of control based on input from an input unit 20 is provided.

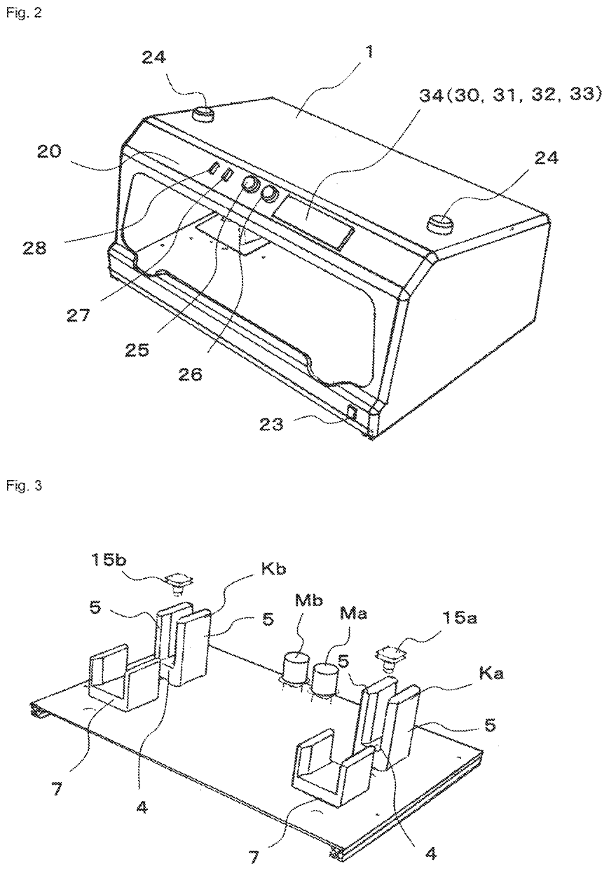

As illustrated in FIG. 2 and FIG. 8, the input unit 20 includes a mounting unit 22 to which an external memory 21 for storing control data is to be removably mounted. Further, the input unit 20 includes switches, buttons, and volumes for use in performing various settings and the like. Those switches, buttons, and volumes include a “power switch 23,” a pair of “emergency stop buttons 24,” a “training start button 25,” a “training end button 26,” a “left paralysis/right paralysis switching switch 27,” a “training mode/setting mode switching switch 28,” an “angle restriction volume (extension) 30,” an “angle restriction volume (flexion) 31,” a “speed restriction volume 32,” and a “force restriction volume 33.” As illustrated in FIG. 2, the “angle restriction volume (extension) 30,” the “angle restriction volume (flexion) 31,” the “speed restriction volume 32,” and the “force restriction volume 33” are implemented by a function of a touch panel 34. Functions thereof are described later.

As illustrated in FIG. 8 to FIG. 10, the control unit 40 includes power supply controlling device 41 for controlling, through on or off of the “power switch 23,” supply and stop of power from an AC adapter 35 with respect to each unit including right motor driving device 51a and left motor driving device 51b to be described later. Further, the control unit 40 includes execution device 42 for setting control conditions for various types of controlling device included in the control unit 40 and also executing functions thereof. The “training mode/setting mode switching switch 28” of the input unit 20 performs switching between a setting mode of performing various settings to the execution device 42 from the input unit 20, and a training mode of performing a training by actually operating the apparatus after the setting. The “training start button 25” gives an instruction to start the operation of the apparatus in the training mode. The “training end button 26” gives an instruction to end the operation.

Further, the control unit 40 includes motor controlling device 50 for controlling the right motor Ma and the left motor Mb. The motor controlling device 50 includes the right motor driving device 51a, the left motor driving device 51b, and drive controlling device 52. The right motor driving device 51a is supplied with power to drive the right motor Ma. The left motor driving device 51b is supplied with power to drive the left motor Mb. The drive controlling device 52 causes the right motor driving device 51a and the left motor driving device 51b to perform bilateral control. The drive controlling device 52 causes bilateral control to be performed, in which, when the right motor Ma is rotated via the right movable unit Ka by an external force of the right hand Ha, or when the left motor Mb is rotated via the left movable unit Kb by an external force of the left hand Hb, similarly to one motor rotated by this external force, another motor is electrically rotated so as to follow the one motor, in a direction reverse to a rotation direction of the one motor.

In the embodiment, the drive controlling device 52 compares a rotation angle detected by the right rotation angle detector 10a and a rotation angle detected by the left rotation angle detector 10b with each other to cause the right motor driving device 51a and the left motor driving device 51b to control the respective motors to perform reverse rotation so that a difference between those rotation angles is reduced. That is, the drive controlling device 52 detects that, while the right motor Ma and the left motor Mb are stopped or rotated, any one motor is additionally rotated as compared to another motor by the external force, and causes the another motor to rotate.

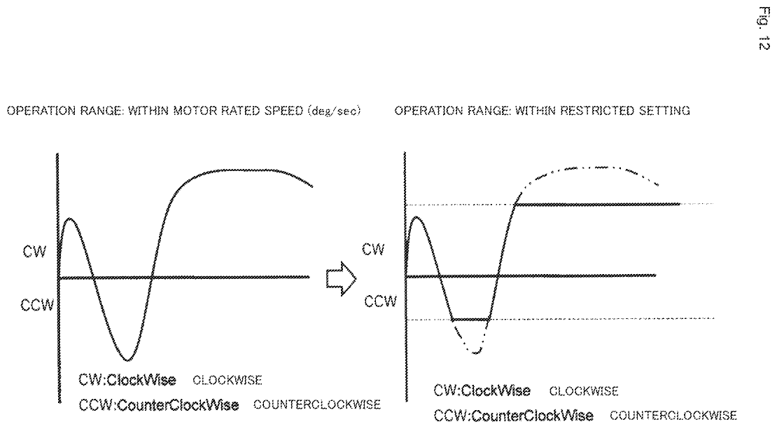

Further, the execution device 42 includes right movable angle range setting device 53a and left movable angle range setting device 53b. The right movable angle range setting device 53a sets, through input from the input unit 20, a right movable angle range having a starting point position of the right movable unit Ka as a reference. The left movable angle range setting device 53b sets, through input from the input unit 20, a left movable angle range having a starting point position of the left movable unit Kb as a reference. In detail, as illustrated in FIG. 11, in the embodiment, an angle range of each of the movable units Ka and Kb can be set as follows. Specifically, through use of a turning position (mechanical limit in a flexing direction) of each of the movable units Ka and Kb in a state in which the four fingers are folded being set as the starting point position (0°), the angle range can be set within a range from this starting point position to a turning position (mechanical limit in the extending direction) of each of the movable units Ka and Kb in a state of being turned by 75° so that the four fingers are linearly extended. In this case, each of the movable units Ka and Kb can be stopped by a stopper (not shown), and the mechanical limit refers to its “stop angle position.” Through the operation of the “angle restriction volume (flexion) 31” provided in the input unit 20, an angle from the starting point position at the flexing position is set, and, through the operation of the “angle restriction volume (extension) 30,” an angle from the starting point position at the extending position is set. For example, as illustrated in FIG. 11, when the left hand Hb is the paralyzed hand and the right hand Ha is the healthy hand, the angle on the paralyzed hand side being the left hand Hb side is set to from 25° (flexing position) to 65° (extending position). The angle on the healthy hand side being the right hand Ha side is set to 3° (flexing position) to 70° (extending position). When the power is input and the “training end button 26” is pressed, the motor controlling device 50 causes the right motor driving device 51a and the left motor driving device 51b to position and stop the right motor Ma and the left motor Mb at initial positions so that the movable units Ka and Kb are located at the flexing positions.

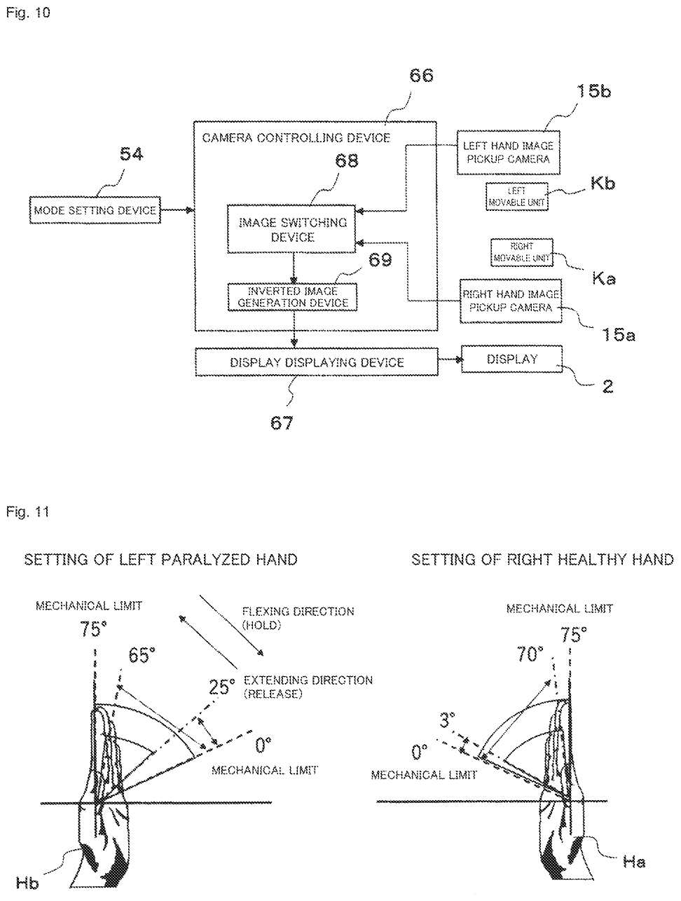

The execution device 42 includes mode setting device 54 (FIG. 10) for performing, through input from the “left paralysis/right paralysis switching switch 27” of the input unit 20, switching setting to any of a left hand training mode to be performed when the right hand Ha is the healthy hand and the left hand Hb is the paralyzed hand or a right hand training mode to be performed when the right hand Ha is the paralyzed hand and the left hand Hb is the healthy hand. Accordingly, when the mode setting device 54 sets the left hand training mode, the input to the right movable angle range setting device 53a becomes the right movable angle range setting on the healthy hand side, and the input to the left movable angle range setting device 53b becomes the left movable angle range setting on the paralyzed hand side. The right movable angle range of the right movable unit Ka is not particularly required to be set. Meanwhile, when the mode setting device 54 sets the right hand training mode, the input to the right movable angle range setting device 53a becomes the right movable angle range setting on the paralyzed hand side, and the input to the left movable angle range setting device 53b becomes the left movable angle range setting on the healthy hand side. The left movable angle range of the left movable unit Kb is not particularly required to be set.

Further, the control unit 40 includes storage device 55. The storage device 55 stores a right motor rotation angle range of the right motor Ma corresponding to the right movable angle range set by the right movable angle range setting device 53a and a left motor rotation angle range of the left motor Mb corresponding to the left movable angle range set by the left movable angle range setting device 53b. In this case, the rotation ratio between the motor Ma or Mb and the movable unit Ka or Kb is 1:1 in the embodiment, and hence the rotation angle range of the motor Ma or Mb is the same as the movable angle range of the movable unit Ka or Kb.

Further, the motor controlling device 50 includes right rotation angle restricting device 56a and left rotation angle restricting device 56b. The right rotation angle restricting device 56a allows electric drive of the right motor Ma by the right motor driving device 51a when the right rotation angle detected by the right rotation angle detector 10a falls within the right motor rotation angle range stored in the storage device 55, and restricts the electric drive of the right motor Ma by the right motor driving device 51a when the right rotation angle detected by the right rotation angle detector 10a has reached an upper limit or a lower limit of the right motor rotation angle range stored in the storage device 55. The left rotation angle restricting device 56b allows electric drive of the left motor Mb by the left motor driving device 51b when the left rotation angle detected by the left rotation angle detector 10b falls within the left motor rotation angle range stored in the storage device 55, and restricts the electric drive of the left motor Mb by the left motor driving device 51b when the left rotation angle detected by the left rotation angle detector 10b has reached an upper limit or a lower limit of the left motor rotation angle range stored in the storage device 55.

Moreover, the execution device 42 includes right upper-limit speed setting device 57a and left upper-limit speed setting device 57b. The right upper-limit speed setting device 57a sets, through input from the “speed restriction volume 32” of the input unit 20, a right upper-limit speed that is an upper limit of a turning speed of the right movable unit Ka. The left upper-limit speed setting device 57b sets, through input from the input unit 20, a left upper-limit speed that is an upper limit of a turning speed of the left movable unit Kb. The storage device 55 of the control unit 40 stores a right motor upper-limit speed of the right motor Ma corresponding to the right upper-limit speed set by the right upper-limit speed setting device 57a and a left motor upper-limit speed of the left motor Mb corresponding to the left upper-limit speed set by the left upper-limit speed setting device 57b. In detail, as shown in FIG. 12, the upper-limit speed setting performs an operation of fixing an upper limit of a rated angular velocity (deg/sec) of the motor in each of a forward rotation direction and a reverse rotation direction.

The motor controlling device 50 includes right rotation speed calculating device 58a, left rotation speed calculating device 58b, right rotation speed restricting device 59a, and left rotation speed restricting device 59b. The right rotation speed calculating device 58a calculates the rotation speed of the right motor Ma. The left rotation speed calculating device 58b calculates the rotation speed of the left motor Mb. The right rotation speed restricting device 59a allows electric drive of the right motor Ma by the right motor driving device 51a when a right rotation speed calculated by the right rotation speed calculating device 58a is less than the right motor upper-limit speed stored in the storage device 55, and restricts the electric drive of the right motor Ma by the right motor driving device 51a when the right rotation speed calculated by the right rotation speed calculating device 58a is equal to or larger than the right motor upper-limit speed stored in the storage device 55. The left rotation speed restricting device 59b allows electric drive of the left motor Mb by the left motor driving device 51b when a left rotation speed calculated by the left rotation speed calculating device 58b is less than the left motor upper-limit speed stored in the storage device 55, and restricts the electric drive of the left motor Mb by the left motor driving device 51b when the left rotation speed calculated by the left rotation speed calculating device 58b is equal to or larger than the left motor upper-limit speed stored in the storage device 55.

When the mode setting device 54 sets the left hand training mode, the input to the right upper-limit speed setting device 57a becomes the right upper-limit speed setting on the healthy hand side, and the input to the left upper-limit speed setting device 57b becomes the left upper-limit speed setting on the paralyzed hand side. The right upper-limit speed of the right movable unit Ka is not particularly required to be set. Meanwhile, when the mode setting device 54 sets the right hand training mode, the input to the right upper-limit speed setting device 57a becomes the right upper-limit speed setting on the paralyzed hand side, and the input to the left upper-limit speed setting device 57b becomes the left upper-limit speed setting on the healthy hand side. The left upper-limit speed of the left movable unit Kb is not particularly required to be set.

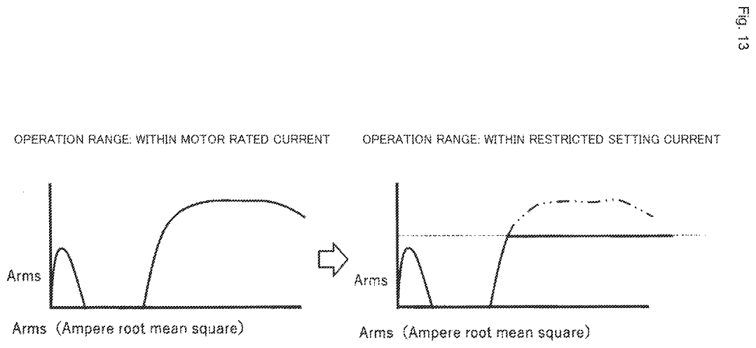

Further, the execution device 42 includes right upper-limit force setting device 60a and left upper-limit force setting device 60b. The right upper-limit force setting device 60a sets, through input from the “force restriction volume 33” of the input unit 20, a right upper-limit force that is an upper limit of a turning force of the right movable unit Ka. The left upper-limit force setting device 60b sets, through input from the input unit 20, a left upper-limit force that is an upper limit of a turning force of the left movable unit Kb. The storage device 55 stores a right motor upper-limit load of the right motor Ma corresponding to the right upper-limit force set by the right upper-limit force setting device 60a and a left motor upper-limit load of the left motor Mb corresponding to the left upper-limit force set by the left upper-limit force setting device 60b. In detail, as shown in FIG. 13, in the embodiment, as the upper-limit load, an upper-limit current value determined by restricting an upper limit of a rated current value of each of the motors Ma and Mb is stored. The current value as the load corresponds to torque of the motor.

The motor controlling device 50 includes right load calculating device 61a, left load calculating device 61b, right rotation force restricting device 62a, and left rotation force restricting device 62b. The right load calculating device 61a calculates a load (current value) of the right motor Ma. The left load calculating device 61b calculates a load (current value) of the left motor Mb. The right rotation force restricting device 62a allows electric drive of the right motor Ma by the right motor driving device 51a when a right load calculated by the right load calculating device 61a is less than the right motor upper-limit load stored in the storage device 55, and restricts the electric drive of the right motor Ma by the right motor driving device 51a when the right load calculated by the right load calculating device 61a is equal to or larger than the right motor upper-limit load stored in the storage device 55. The left rotation force restricting device 62b allows electric drive of the left motor Mb by the left motor driving device 51b when a left load calculated by the left load calculating device 61b is less than the left motor upper-limit load stored in the storage device 55, and restricts the electric drive of the left motor Mb by the left motor driving device 51b when the left load calculated by the left load calculating device 61b is equal to or larger than the left motor upper-limit load stored in the storage device 55.

When the mode setting device 54 sets the left hand training mode, the input to the right upper-limit force setting device 60a becomes the right upper-limit force setting on the healthy hand side, and the input to the left upper-limit force setting device 60b becomes the left upper-limit force setting on the paralyzed hand side. The right upper-limit force of the right movable unit Ka is not particularly required to be set. Meanwhile, when the mode setting device 54 sets the right hand training mode, the input to the right upper-limit force setting device 60a becomes the right upper-limit force setting on the paralyzed hand side, and the input to the left upper-limit force setting device 60b becomes the left upper-limit force setting on the healthy hand side. The left upper-limit force of the left movable unit Kb is not particularly required to be set.

As illustrated in FIG. 8, the motor controlling device 50 includes a controller 63 to be operated by a command from the execution device 42. The controller 63 includes functions to be performed by the above-mentioned drive controlling device 52, right rotation angle restricting device 56a, left rotation angle restricting device 56b, right rotation speed calculating device 58a, left rotation speed calculating device 58b, right rotation speed restricting device 59a, left rotation speed restricting device 59b, right load calculating device 61a, left load calculating device 61b, right rotation force restricting device 62a, and left rotation force restricting device 62b.

Further, the control unit 40 includes a timer (not shown) to be operated through pressing of the “training start button 25.” When a setting time of the timer arrives, the drive of each of the right motor Ma and the left motor Mb is stopped to stop the training. The setting time of the timer is set to, for example, three minutes. Further, the control unit 40 includes emergency stop device 64 for transmitting an abnormality signal through input from the “emergency stop buttons 24” of the input unit 20 so as to forcibly stop the drive of each of the right motor Ma and the left motor Mb via the power supply controlling device 41 based on this abnormality signal.

Moreover, the control unit 40 includes, as illustrated in FIG. 8 and FIG. 10, illumination controlling device 65, camera controlling device 66, and display displaying device 67. The illumination controlling device 65 controls the right LED lamp 16a and the left LED lamp 16b. The camera controlling device 66 controls the right hand image pickup camera 15a and the left hand image pickup camera 15b. The display displaying device 67 controls display of the display 2. The illumination controlling device 65 controls an illuminance of each of the right LED lamp 16a and the left LED lamp 16b. The illumination controlling device 65 turns on the right LED lamp 16a and the left LED lamp 16b so as to brighten the hands and make images picked up by the image pickup cameras 15a and 15b clear.

The camera controlling device 66 includes image switching device 68 and inverted image generation device 69. When the mode setting device 54 sets the left hand training mode, the image switching device 68 enables image pickup data obtained from the right hand image pickup camera 15a and disables image pickup data obtained from the left hand image pickup camera 15b, while, when the mode setting device 54 sets the right hand training mode, the image switching device 68 disables the image pickup data obtained from the right hand image pickup camera 15a and enables the image pickup data obtained from the left hand image pickup camera 15b. The inverted image generation device 69 generates an inverted image obtained by mirror-inverting the normal image enabled by the image switching device 68.

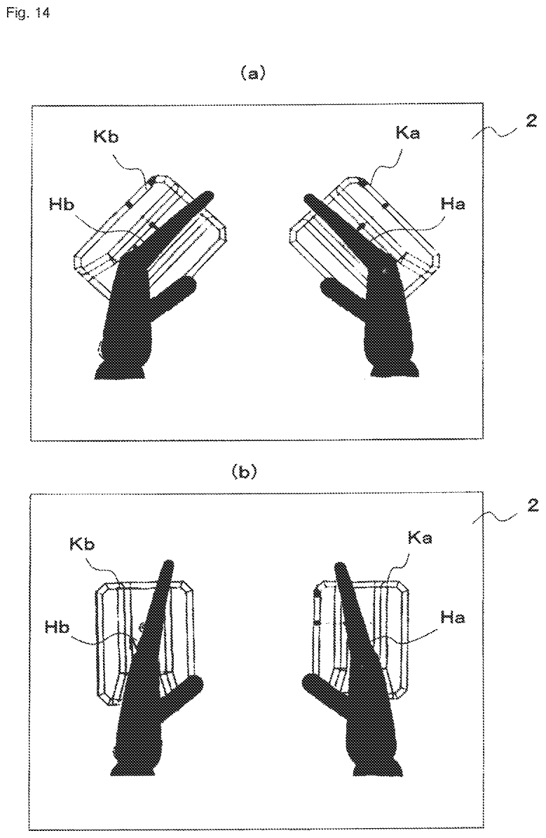

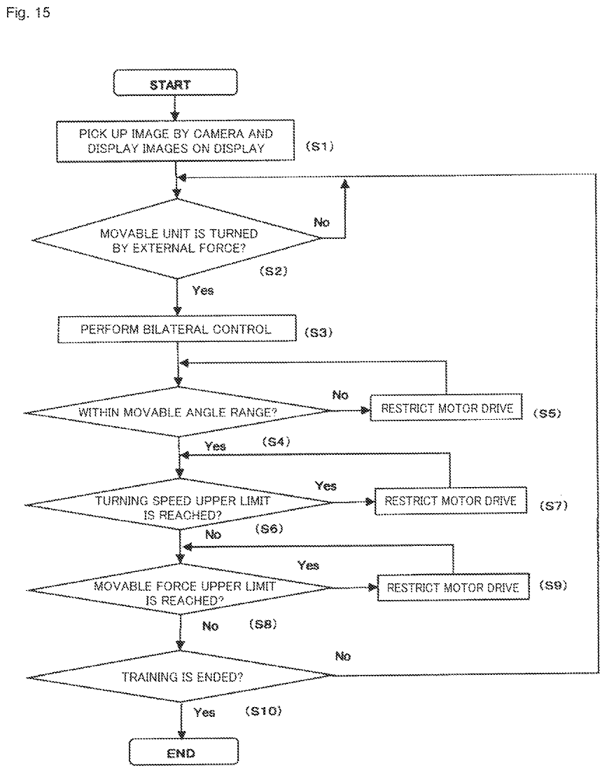

The display displaying device 67 has a function of displaying, as illustrated in FIG. 14(a) and FIG. 14(b), the normal image enabled by the image switching device 68 and the inverted image generated by the inverted image generation device 69 on the display 2. In this manner, a training of moving a hand corresponding to another image pickup camera side disabled by the image switching device 68 while visually recognizing the normal image and the inverted image displayed on the display 2 is performed. The display displaying device 67 also has, for example, a function of displaying an initial setting screen (not shown) when the setting mode is set through input of the “training mode/setting mode switching switch 28” of the input unit 20.

Accordingly, the patient uses the rehabilitation apparatus S according to the embodiment to perform the rehabilitation as follows. An assistant or the like of the patient turns on the “power switch 23,” and sets the setting mode in advance through input of the “training mode/setting mode switching switch 28” to perform the initial setting. Description is given here of a case of a patient whose right hand Ha is the healthy hand and left hand Hb is the paralyzed hand.

Through input from the “left paralysis/right paralysis switching switch 27” of the input unit 20, the left hand training mode is set. In addition, through operation of the “angle restriction volume (flexion) 31” provided in the input unit 20, an angle from the starting point position at the flexing position is set. Through operation of the “angle restriction volume (extension) 30,” an angle from the starting point position at the extending position is set. In this case, the input to the right movable angle range setting device 53a becomes the right movable angle range setting on the healthy hand side (which is generally a large angle range), and the input to the left movable angle range setting device 53b becomes the left movable angle range setting on the paralyzed hand side (which is generally an angle range smaller than that of the right). In this manner, as illustrated in FIG. 11, the right motor rotation angle range of the right motor Ma corresponding to the right movable angle range set by the right movable angle range setting device 53a and the left motor rotation angle range of the left motor Mb corresponding to the left movable angle range set by the left movable angle range setting device 53b are stored in the storage device 55.

Further, through input from the “speed restriction volume 32” of the input unit 20, the right upper-limit speed that is the upper limit of the turning speed of the right movable unit Ka is set, and the left upper-limit speed that is the upper limit of the turning speed of the left movable unit Kb is set. In this case, the mode setting device 54 is set to the left hand training mode, and hence the input to the right upper-limit speed setting device 57a becomes the right upper-limit speed setting on the healthy hand side (which is generally a large upper-limit speed), and the input to the left upper-limit speed setting device 57b becomes the left upper-limit speed setting on the paralyzed hand side (which is generally an upper-limit speed smaller than that of the right). As shown in FIG. 12, the right motor upper-limit speed of the right motor Ma corresponding to the right upper-limit speed and the left motor upper-limit speed of the left motor Mb corresponding to the left upper-limit speed set by the left upper-limit speed setting device 57b are set and stored in the storage device 55.

Moreover, through input from the “force restriction volume 33” of the input unit 20, the right upper-limit force that is the upper limit of the turning force of the right movable unit Ka is set, and the left upper-limit force that is the upper limit of the turning force of the left movable unit Kb is set. In this case, the mode setting device 54 is set to the left hand training mode, and hence the input to the right upper-limit force setting device 60a becomes the right upper-limit force setting on the healthy hand side (which is generally a large upper-limit force), and the input to the left upper-limit force setting device 60b becomes the left upper-limit force setting on the paralyzed hand side (which is generally an upper-limit force smaller than that of the right). As shown in FIG. 13, the right motor upper-limit load of the right motor Ma corresponding to the right upper-limit force set by the right upper-limit force setting device 60a and the left motor upper-limit load of the left motor Mb corresponding to the left upper-limit force set by the left upper-limit force setting device 60b are stored in the storage device 55.

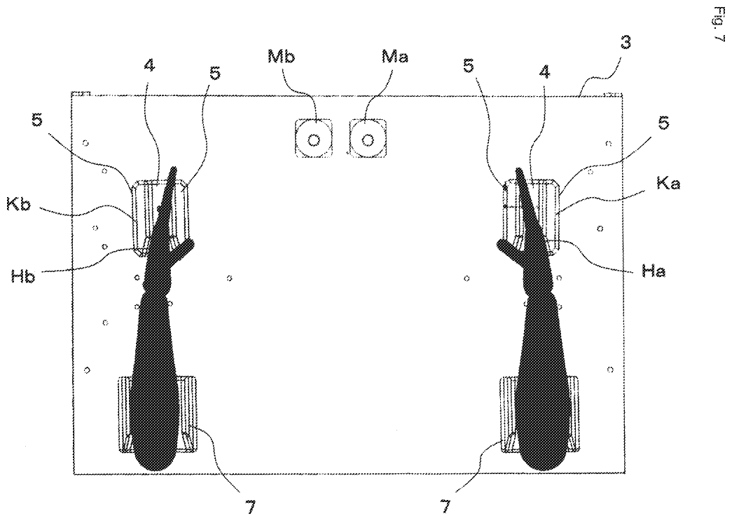

When the setting in the input unit 20 is finished, the mode is switched to the training mode through use of the “training mode/setting mode switching switch 28.” Then, as illustrated in FIG. 6, the right hand Ha being the healthy hand is placed on the supporting member 4 of the right movable unit Ka, and the left hand Hb being the paralyzed hand is placed on a supporting portion of the left movable unit Kb. In this case, the wrist-side holding unit 7 holds the wrist side of the hand, and hence the four fingers are reliably supported.

Now, description is given of a control flow of the controlling device with reference to the flow chart of FIG. 15. When the “training start button 25” is pressed, the training is started. When the training is started, the illumination controlling device 65 turns on the right LED lamp 16a and the left LED lamp 16b, and the image switching device 68 of the camera controlling device 66 enables the image pickup data of the right hand image pickup camera 15a. Further, the inverted image generation device 69 generates an inverted image obtained by mirror-inverting the normal image of the image pickup data. As illustrated in FIG. 14(a) and FIG. 14(b), on the display 2, the display displaying device 67 displays the normal image enabled by the image switching device 68 and the inverted image generated by the inverted image generation device 69 side by side so as to correspond to the positions of the right hand Ha and the left hand Hb (Step S1).

Further, in the motor controlling device 50, the drive controlling device 52 detects rotation caused by the external force of each of the right motor Ma and the left motor Mb (Step S2). When the right motor Ma is rotated via the right movable unit Ka by the external force of the right hand Ha, or when the left motor Mb is rotated via the left movable unit Kb by the external force of the left hand Hb (Yes in Step S2), the drive controlling device 52 performs bilateral control in which, similarly to one motor rotated by this external force, another motor is electrically rotated so as to follow the one motor, in a direction reverse to a rotation direction of the one motor (Step S3).

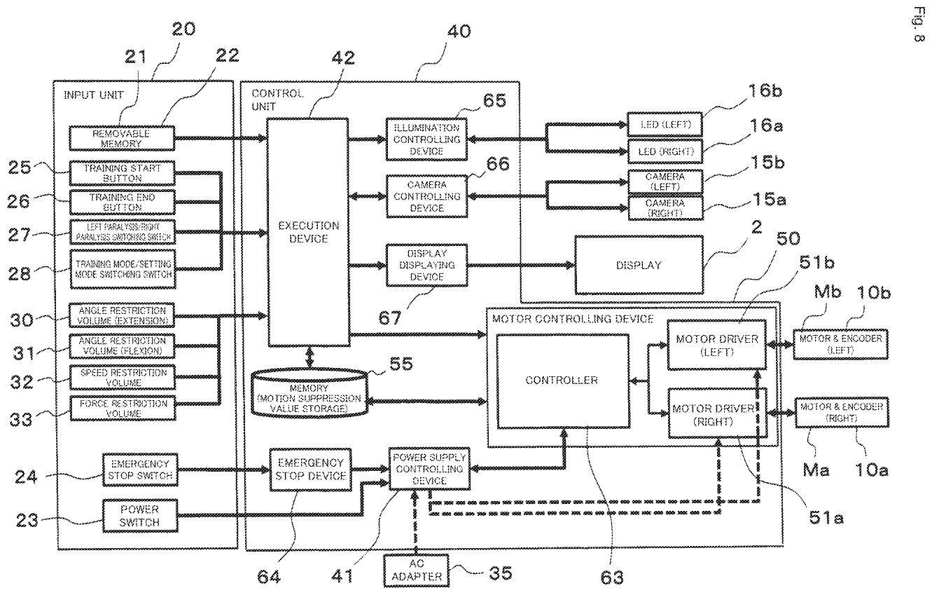

In general, the movement of the movable unit on the healthy hand side is smooth, and hence, as illustrated in FIG. 6 and FIG. 7, the movable unit on the paralyzed hand side is moved so as to follow the movement on the healthy hand side. Accordingly, the paralyzed hand being the left hand Hb coordinated with the left movable unit Kb can be moved similarly to the healthy hand being the right hand Ha coordinated with the right movable unit Ka. That is, when the right hand Ha is flexed to move the right movable unit Ka, the left hand Hb is also moved in the flexing direction by the left movable unit Kb. Further, when the right hand Ha is extended to move the right movable unit Ka, the left hand Hb is also moved in the extending direction by the left movable unit Kb. Those motions can be repeatedly performed. In this case, the drive controlling device 52 performs the bilateral control, and hence the movement of the healthy hand can be faithfully transmitted to the paralyzed hand.

In addition, its responsiveness is well, and hence, as compared to the related art, the performance can be improved, and the reliability can be improved.

Further, a training of moving the hands while visually recognizing the normal image and the inverted image displayed on the display 2 can be performed. In this case, as illustrated in FIG. 14(a) and FIG. 14(b), the display 2 displays the normal image of the healthy hand being the right hand Ha and its inverted image, and hence the patient views a video that looks as if the paralyzed hand being the left hand Hb was also smoothly moved similarly to the healthy hand being the right hand Ha. Accordingly, this visual input stimulates the brain to provide a sense that the patient himself or herself is smoothly moving the paralyzed hand being paralyzed, thereby producing an action of assisting the exercise of the paralyzed hand and being capable of obtaining a high rehabilitation effect.

In the process of this bilateral control, the right rotation angle detector 10a detects the rotation angle of the right motor Ma, and the left rotation angle detector 10b detects the rotation angle of the left motor Mb (Step S4). The right rotation angle restricting device 56a performs the electric drive of the right motor Ma when the right rotation angle detected by the right rotation angle detector 10a falls within the right motor rotation angle range (Yes in Step S4), and when the right rotation angle detected by the right rotation angle detector 10a has reached the upper limit or the lower limit of the right motor rotation angle range (No in Step S4), the right rotation angle restricting device 56a restricts the electric drive of the right motor Ma by the right motor driving device 51a (Step S5). Meanwhile, the left rotation angle restricting device 56b performs the electric drive of the left motor Mb when the left rotation angle detected by the left rotation angle detector 10b falls within the left motor rotation angle range (Yes in Step S4), and when the left rotation angle detected by the left rotation angle detector 10b has reached the upper limit or the lower limit of the left motor rotation angle range (No in Step S4), the left rotation angle restricting device 56b restricts the electric drive of the left motor Mb by the left motor driving device 51b (Step S5).

Accordingly, the right motor Ma or the left motor Mb whose drive has been restricted is not electrically rotated forcibly, and hence the electric movement of the right movable unit Ka or the left movable unit Kb can be restricted, and forcible turning can be suppressed. That is, in a case of this example in which the left hand Hb is the paralyzed hand and the right hand Ha is the healthy hand, when the right movable angle range on the healthy hand side being the right hand Ha side is larger than the left movable angle range on the paralyzed hand side being the left hand Hb side, the right movable unit Ka turns to exceed the angle range of the left movable unit Kb. However, in the left movable unit Kb, motive power does not act at the upper limit or the lower limit of the left movable angle, and hence the left movable unit Kb is not forcibly moved. As a result, forcible movement of the paralyzed hand being the left hand Hb can be prevented from being performed, thereby being capable of ensuring safety of the paralyzed hand being the left hand Hb.

Further, in the process of this bilateral control, the right rotation speed calculating device 58a calculates the rotation speed of the right motor Ma, and the left rotation speed calculating device 58b calculates the rotation speed of the left motor Mb. The right rotation speed restricting device 59a allows the electric drive of the right motor Ma by the right motor driving device 51a when the right rotation speed calculated by the right rotation speed calculating device 58a is less than the right motor upper-limit speed (No in Step S6), and when the right rotation speed calculated by the right rotation speed calculating device 58a is equal to or larger than the right motor upper-limit speed (Yes in Step S6), the right rotation speed restricting device 59a restricts the electric drive of the right motor Ma by the right motor driving device 51a (Step S7). Meanwhile, the left rotation speed restricting device 59b allows the electric drive of the left motor Mb by the left motor driving device 51b when the left rotation speed calculated by the left rotation speed calculating device 58b is less than the left motor upper-limit speed (No in Step S6), and when the left rotation speed calculated by the left rotation speed calculating device 58b is equal to or larger than the left motor upper-limit speed (Yes in Step S6), the left rotation speed restricting device 59b restricts the electric drive of the left motor Mb by the left motor driving device 51b (Step S7).

Accordingly, the right motor Ma or the left motor Mb whose drive has been restricted is not electrically rotated forcibly, and hence the electric movement of the right movable unit Ka or the left movable unit Kb can be restricted, and forcible turning can be suppressed. That is, in a case of this example in which the left hand Hb is the paralyzed hand and the right hand Ha is the healthy hand, when the right upper-limit speed on the healthy hand side being the right hand Ha side is larger than the left upper-limit speed on the paralyzed hand side being the left hand Hb side, the right movable unit Ka turns to exceed the left upper-limit speed of the left movable unit Kb. However, the speed of the left movable unit Kb does not become larger than the left upper-limit speed, and hence forcible movement of the paralyzed hand being the left hand Hb can be prevented from being performed, thereby being capable of ensuring safety of the paralyzed hand being the left hand Hb.

Moreover, in the process of this bilateral control, the right load calculating device 61a calculates the load of the right motor Ma, and the left load calculating device 61b calculates the load of the left motor Mb. The right rotation force restricting device 62a allows the electric drive of the right motor Ma by the right motor driving device 51a when the right load calculated by the right load calculating device 61a is less than the right motor upper-limit load (No in Step S8), and when the right load calculated by the right load calculating device 61a is equal to or larger than the right motor upper-limit load (Yes in Step S8), the right rotation force restricting device 62a restricts the electric drive of the right motor Ma by the right motor driving device 51a (Step S9). Meanwhile, the left rotation force restricting device 62b allows the electric drive of the left motor Mb by the left motor driving device 51b when the left load calculated by the left load calculating device 61b is less than the left motor upper-limit load (No in Step S8), and when the left load calculated by the left load calculating device 61b is equal to or larger than the left motor upper-limit load (Yes in Step S8), the left rotation force restricting device 62b restricts the electric drive of the left motor Mb by the left motor driving device 51b (Step S9).

Accordingly, the right motor Ma or the left motor Mb whose drive has been restricted is not electrically rotated forcibly, and hence the electric movement of the right movable unit Ka or the left movable unit Kb can be restricted, and forcible turning can be suppressed. That is, in a case of this example in which the left hand Hb is the paralyzed hand and the right hand Ha is the healthy hand, when the right upper-limit force on the healthy hand side being the right hand Ha side is larger than the left upper-limit force on the paralyzed hand side being the left hand Hb side, the right movable unit Ka turns to exceed the left upper-limit force of the left movable unit Kb. However, the left movable unit Kb does not output a force equal to or larger than the left upper-limit force, and hence forcible movement of the paralyzed hand being the left hand Hb can be prevented from being performed, thereby being capable of ensuring safety of the paralyzed hand being the left hand Hb.

Such a training obtained by the bilateral control can be performed until the setting time of the timer arrives or until the “training end button 26” is pressed (No in Step S10). When the setting time of the timer arrives or the “training end button 26” is pressed, the training is ended (Yes in Step S10). Further, when any trouble occurs during the training, the “emergency stop button 24” is pressed. In this manner, the drive of each of the right motor Ma and the left motor Mb is forcibly stopped via the power supply controlling device 41 by the emergency stop device 64, thereby being capable of ensuring safety.

Meanwhile, conversely to the above, in a case of a patient whose right hand Ha is the paralyzed hand and left hand Hb is the healthy hand, through input from the “left paralysis/right paralysis switching switch 27” of the input unit 20, the right hand training mode is set. Then, similarly to the above, the movable angle ranges are set through the operations of the “angle restriction volume (flexion) 31” and the “angle restriction volume (extension) 30” so that right and left conditions are reversed. Through input from the “speed restriction volume 32,” the upper-limit speed of each of the movable units Ka and Kb is set. Through input from the “force restriction volume 33,” the upper-limit force of the turning force of each of the movable units Ka and Kb is set. When the setting in the input unit 20 is finished, through the “training mode/setting mode switching switch 28,” the mode is switched to the training mode. Then, the right hand Ha being the paralyzed hand is placed on the supporting member 4 of the right movable unit Ka, and the left hand Hb being the healthy hand is placed on the supporting portion of the left movable unit Kb so that the training is started. In this manner, similarly to the paralyzed hand being the left hand Hb described above, the training of the paralyzed hand being the right hand Ha can be performed, and actions and effects similar to those described above can be provided.

That is, according to this rehabilitation apparatus S, when the training of the paralyzed hand is performed, no matter which of the right hand Ha or the left hand Hb is the paralyzed hand, the patient coordinates the right hand Ha with the right movable unit Ka and coordinates the left hand Hb with the left movable unit Kb, and moves the right and left hands in the same way. In this case, when the right motor Ma is rotated via the right movable unit Ka by an external force of the right hand Ha, or when the left motor Mb is rotated via the left movable unit Kb by an external force of the left hand Hb, the drive controlling device 52 performs the bilateral control in which, similarly to one motor rotated by the external force, another motor is electrically rotated so as to follow the one motor, in a direction reverse to the rotation direction of the one motor.

In general, the movement of the movable unit on the healthy hand side is smooth, and hence the movable unit on the paralyzed hand side is moved so as to follow the movement on the healthy hand side. Accordingly, no matter which of the right hand Ha or the left hand Hb is the paralyzed hand, the paralyzed hand can be moved similarly to the healthy hand. Accordingly, the two modes of paralysis, specifically, the case in which the left hand Hb is the paralyzed hand and the right hand Ha is the healthy hand and the case in which the right hand Ha is the paralyzed hand and the left hand Hb is the healthy hand, can be handled by one apparatus, thereby being capable of improving the versatility.

Further, the drive controlling device 52 performs the bilateral control, and hence the movement of the healthy hand can be faithfully transmitted to the paralyzed hand. In addition, its responsiveness is well, and hence, as compared to the related art, the performance can be improved, and the reliability can be improved.

In the above-mentioned embodiment, each of the motors Ma and Mb is configured to perform rotation transmission to a corresponding one of the movable units Ka and Kb via the rotation transmission mechanism 11 including the timing belt 14, but the present invention is not necessarily limited thereto. A configuration using a gear transmission mechanism may be employed. Further, its rotation ratio may be determined as appropriate, and may be changed as appropriate without problems. Further, each of the motors Ma and Mb may be directly coupled to a corresponding one of the movable units Ka and Kb. Further, each of the movable units Ka and Kb is configured to adapt to a bending motion of bending other four fingers excluding the thumb from the MP joints, but the present invention is not necessarily limited thereto. A configuration adaptable to bending from other joints may be employed, and may be changed as appropriate without problems. Moreover, the configuration of each of the input unit 20 and the control unit 40 is also not limited to the above-mentioned configuration, and the configuration may be changed as appropriate without problems. In short, the present invention is not limited to the above-mentioned embodiment of the present invention, and those skilled in the art can readily appreciate that many modifications can be added to the exemplary embodiment without materially departing from the novel teachings and advantages of the present invention. Accordingly, those many modifications are included within the scope of the present invention.

The documents described herein and the specification of Japanese application on the basis of which the present application claims Paris convention priority are incorporated herein by reference in its entirety.

### REFERENCE SIGNS LIST

S rehabilitation apparatus
Ha right hand
Hb left hand
1 accommodation box
2 display
3 base
Ka right movable unit
Kb left movable unit
4 supporting member
5 abutment plate
6 turning shaft
7 wrist-side holding unit
Ma right motor
Mb left motor
10a right rotation angle detector
10b left rotation angle detector
11 rotation transmission mechanism
12 main pulley
13 driven pulley
14 timing belt
15a right hand image pickup camera
15b left hand image pickup camera
16a right LED lamp
16b left LED lamp
20 input unit
21 external memory
22 mounting unit
23 power switch
24 emergency stop button
25 training start button
26 training end button
27 left paralysis/right paralysis switching switch
28 training mode/setting mode switching switch
30 angle restriction volume (extension)
31 angle restriction volume (flexion)
32 speed restriction volume
33 force restriction volume
34 touch panel
35 AC adapter
40 control unit
41 power supply controlling device
42 execution device
50 motor controlling device
51a right motor driving device
51b left motor driving device
52 drive controlling device
53a right movable angle range setting device
53b left movable angle range setting device
54 mode setting device
55 storage device
56a right rotation angle restricting device
56b left rotation angle restricting device
57a right upper-limit speed setting device
57b left upper-limit speed setting device
58a right rotation speed calculating device
58b left rotation speed calculating device
59a right rotation speed restricting device
59b left rotation speed restricting device
60a right upper-limit force setting device
60b left upper-limit force setting device
61a right load calculating device
61b left load calculating device
62a right rotation force restricting device
62b left rotation force restricting device
63 controller
64 emergency stop device
65 illumination controlling device
66 camera controlling device
67 display displaying device
68 image switching device
69 inverted image generation device

1. A rehabilitation apparatus for performing, when any one of right and left hands is a healthy hand being healthy and another of the right and left hands is a paralyzed hand being paralyzed and disabled, a training of moving the paralyzed hand similarly to the healthy hand, the rehabilitation apparatus comprising:
a right movable unit to be coordinated with a right hand;
a left movable unit to be coordinated with a left hand;
a right motor configured to electrically turn the right movable unit;
a left motor configured to electrically turn the left movable unit; and
a control unit including motor controlling device for controlling the right motor and the left motor,
wherein the motor controlling device includes:
a right motor driving device for driving the right motor;
a left motor driving device for driving the left motor; and
a drive controlling device for causing the right motor driving device and the left motor driving device to perform bilateral control in which, when the right motor is rotated via the right movable unit by an external force of the right hand or when the left motor is rotated via the left movable unit by an external force of the left hand, similarly to one motor rotated by the external force, another motor is electrically rotated so as to follow the one motor, in a direction reverse to a rotation direction of the one motor.

2. The rehabilitation apparatus according to claim 1, further comprising:
a right rotation angle detector configured to detect a rotation angle of the right motor; and
a left rotation angle detector configured to detect a rotation angle of the left motor,
wherein the drive controlling device is configured to cause the right motor driving device and the left motor driving device to perform control based on the rotation angle detected by the right rotation angle detector and the rotation angle detected by the left rotation angle detector.

3. The rehabilitation apparatus according to claim 2,
wherein the control unit includes:
a right movable angle range setting device for setting, through input from an input unit, a right movable angle range having a starting point position of the right movable unit as a reference;
a left movable angle range setting device for setting, through input from the input unit, a left movable angle range having a starting point position of the left movable unit as a reference; and
a storage device for storing a right motor rotation angle range of the right motor corresponding to the right movable angle range set by the right movable angle range setting device and a left motor rotation angle range of the left motor corresponding to the left movable angle range set by the left movable angle range setting device, and
wherein the motor controlling device includes:
a right rotation angle restricting device for allowing electric drive of the right motor by the right motor driving device when a right rotation angle detected by the right rotation angle detector falls within the right motor rotation angle range stored in the storage device, and restricting the electric drive of the right motor by the right motor driving device when the right rotation angle detected by the right rotation angle detector has reached an upper limit or a lower limit of the right motor rotation angle range stored in the storage device; and
a left rotation angle restricting device for allowing electric drive of the left motor by the left motor driving device when a left rotation angle detected by the left rotation angle detector falls within the left motor rotation angle range stored in the storage device, and restricting the electric drive of the left motor by the left motor driving device when the left rotation angle detected by the left rotation angle detector has reached an upper limit or a lower limit of the left motor rotation angle range stored in the storage device.

4. The rehabilitation apparatus according to claim 1,
wherein the control unit includes:
a right upper-limit speed setting device for setting, through input from an input unit, a right upper-limit speed that is an upper limit of a turning speed of the right movable unit;
a left upper-limit speed setting device for setting, through input from the input unit, a left upper-limit speed that is an upper limit of a turning speed of the left movable unit; and
a storage device for storing a right motor upper-limit speed of the right motor corresponding to the right upper-limit speed set by the right upper-limit speed setting device and a left motor upper-limit speed of the left motor corresponding to the left upper-limit speed set by the left upper-limit speed setting device, and
wherein the motor controlling device includes:
a right rotation speed calculating device for calculating a rotation speed of the right motor;
a left rotation speed calculating device for calculating a rotation speed of the left motor;
a right rotation speed restricting device for allowing electric drive of the right motor by the right motor driving device when a right rotation speed calculated by the right rotation speed calculating device is less than the right motor upper-limit speed stored in the storage device, and restricting the electric drive of the right motor by the right motor driving device when the right rotation speed calculated by the right rotation speed calculating device is equal to or larger than the right motor upper-limit speed stored in the storage device; and
left rotation speed restricting device for allowing electric drive of the left motor by the left motor driving device when a left rotation speed calculated by the left rotation speed calculating device is less than the left motor upper-limit speed stored in the storage device, and restricting the electric drive of the left motor by the left motor driving device when the left rotation speed calculated by the left rotation speed calculating device is equal to or larger than the left motor upper-limit speed stored in the storage device.

5. The rehabilitation apparatus according to claim 1,
wherein the control unit includes:
a right upper-limit force setting device for setting, through input from an input unit, a right upper-limit force that is an upper limit of a turning force of the right movable unit;
a left upper-limit force setting device for setting, through input from the input unit, a left upper-limit force that is an upper limit of a turning force of the left movable unit; and
a storage device for storing a right motor upper-limit load of the right motor corresponding to the right upper-limit force set by the right upper-limit force setting device and a left motor upper-limit load of the left motor corresponding to the left upper-limit force set by the left upper-limit force setting device, and
wherein the motor controlling device includes:
a right load calculating device for calculating a load of the right motor;
a left load calculating device for calculating a load of the left motor;
a right rotation force restricting device for allowing electric drive of the right motor by the right motor driving device when a right load calculated by the right load calculating device is less than the right motor upper-limit load stored in the storage device, and restricting the electric drive of the right motor by the right motor driving device when the right load calculated by the right load calculating device is equal to or larger than the right motor upper-limit load stored in the storage device; and
a left rotation force restricting device for allowing electric drive of the left motor by the left motor driving device when a left load calculated by the left load calculating device is less than the left motor upper-limit load stored in the storage device, and restricting the electric drive of the left motor by the left motor driving device when the left load calculated by the left load calculating device is equal to or larger than the left motor upper-limit load stored in the storage device.

6. The rehabilitation apparatus according to claim 1, wherein the control unit includes an emergency stop device for forcibly stopping drive of each of the right motor and the left motor based on an abnormality signal.

7. The rehabilitation apparatus according to claim 1, further comprising:
a right hand image pickup camera configured to pick up an image of the right hand coordinated with the right movable unit;
a left hand image pickup camera configured to pick up an image of the left hand coordinated with the left movable unit; and
a display,
wherein the control unit includes:
a camera controlling device for controlling the right hand image pickup camera and the left hand image pickup camera;
a display displaying device for controlling display of the display; and
a mode setting device for performing, through input from the input unit, switching setting to any one of a left hand training mode or a right hand training mode, the left hand training mode being performed when the right hand is the healthy hand and the left hand is the paralyzed hand, the right hand training mode being performed when the right hand is the paralyzed hand and the left hand is the healthy hand,
wherein the camera controlling device includes:
an image switching device for enabling image pickup data obtained from the right hand image pickup camera and disabling image pickup data obtained from the left hand image pickup camera when the mode setting device sets the left hand training mode, while disabling the image pickup data obtained from the right hand image pickup camera and enabling the image pickup data obtained from the left hand image pickup camera when the mode setting device sets the right hand training mode; and
an inverted image generation device for generating an inverted image by mirror-inverting a normal image enabled by the image switching device, and
wherein the display displaying device has a function of displaying, on the display, the normal image enabled by the image switching device and the inverted image generated by the inverted image generation device.

8. The rehabilitation apparatus according to claim 1,
wherein an exercise of the healthy hand and the paralyzed hand is a bending motion of bending other four fingers excluding a thumb from MP joints, and
wherein each of the right movable unit and the left movable unit is provided on a base, and is configured to include:
a supporting member configured to support a little finger among the four fingers under a state in which the four fingers are positioned in a vertical direction;
a pair of abutment plates provided upright on the supporting member, the pair of abutment plates being configured to face an outer side and an inner side of the four fingers so that the four fingers are brought into abutment against the pair of abutment plates; and
a turning shaft provided on a lower side of the supporting member so that an axis of the turning shaft extends along the vertical direction, the turning shaft being configured to turn the supporting member with respect to the base.

9. The rehabilitation apparatus according to claim 8, further comprising a wrist-side holding unit provided on the base so as to correspond to each of the right movable unit and the left movable unit, the wrist-side holding unit being configured to hold a wrist side of a hand having the four fingers supported by the supporting member.
